(19) United States
(12) Patent Application Publication
(10) Pub. No.: US 2026/0204554 A1
(43) Pub. Date: Jul. 16, 2026

(54) ALUMINUM ALLOYS AS ANODES FOR MANUFACTURING ALUMINUM BATTERIES

(71) Applicant: Brembo S.p.A., Curno, Bergamo (IT)

(72) Inventors: Federico BERTASI, Curno, Bergamo (IT); Marco BANDIERA, Curno, Bergamo (IT); Arianna PAVESI, Curno, Bergamo (IT); Giorgio VALOTA, Curno, Bergamo (IT); Andrea BONFANTI, Curno, Bergamo (IT)

(21) Appl. No.: 19/133,759

(22) PCT Filed: Nov. 28, 2023
(86) PCT No.: PCT/IB2023/061963

§ 371 Date: May 29, 2025

(30) Foreign Application Priority Data
Nov. 29, 2022 (IT) 102022000024522

(51) Int. Cl. H01M 4/46; B22D 21/04; C22C 1/10; C22C 32/00; H01M 4/02; H01M 4/134

(52) U.S. Cl. CPC H01M 4/463; B22D 21/04; C22C 1/1036; C22C 32/0073; H01M 4/134; H01M 2004/027

(57) ABSTRACT

The present invention relates to aluminum alloys for the preparation of anodes to be used in the manufacturing of batteries.

Batteries, also referred to as electrochemical cells or simply cells, are devices capable of directly converting chemical energy into electrical energy, during the discharge phase.

They always consist of at least two electrodes: 1) anode (negative electrode [−]); and 2) cathode (positive electrode [+]); and an electrolyte.

Each “anode+electrolyte” or “cathode+electrolyte” pair is referred to as an anode or cathode half-cell.

During the discharge of a battery, at least the following events occur in the anode half-cell: 1) oxidation of the anode material with associated electron flow exiting from the half-cell; and 2) migration of ions from the anode to the cathode through the electrolyte.

Correspondingly, in the cathode half-cell, the electrons flowing into the circuit outside the battery are used for reduction reactions, which are necessary to keep the charge balance neutral.

Therefore, it is apparent that the electrolyte performs both the task of physically separating anode and cathode and of ensuring adequate ionic conductivity therebetween; indeed, if the anode and the cathode were in electrical contact, a short circuit with cancellation of the cell potential would be generated.

It is common practice in the development of new batteries to develop each material (anode, cathode, and electrolyte) individually at first, then to optimize the anode and cathode half-cells and therefore the anode-electrolyte and cathode-electrolyte pairs, and finally to develop the complete cell.

The recent advancements in portable electronics and automotive applications require the development of higher-performance energy storage systems, i.e., which offer increased energy density, high performance at low temperatures and high power, etc.

Today, lithium batteries cover substantially the entire portable electronics market and also seem to be very promising for automotive applications.

However, lithium does not fully meet the requirements in terms of safety, natural abundance, cost, and toxicity. In particular, the lithium-ion batteries include a combination of unfavorable factors represented by: flammable electrolytes, toxic salts (which release hydrofluoric acid when exposed to moisture), and the combination with cobalt- and nickel-based cathodes, which also have several disadvantages, including high toxicity.

Moreover, lithium is not an abundant element (<0.01% of the Earth's crust), and its deposits are concentrated in only a few countries.

This explains, for example, the growth of its price by more than 20% per year since 2015, generating much concern about the real future supply capacity of this element.

Similar considerations can also be made with reference to the cost and carbon footprint of nickel and cobalt, which are used to obtain some of the most commonly used cathode materials (e.g., NMC Lithium Nickel Cobalt Manganese Oxide).

Specifically, also considering the carbon footprint required for the extraction and processing of raw materials, the location of the break-even-point for an electric car powered by lithium-ion batteries compared to a corresponding vehicle powered by a combustion engine is not clear to date.

As a result, several batteries based on alternative metals have been studied in recent years.

For example, sodium-, magnesium- and aluminum-based devices show inherent advantages over competing lithium-based technologies.

In particular, magnesium and aluminum are highly abundant elements in the Earth's crust (2.1% and 8.1% by weight, respectively), therefore are cheaper and suffer from fewer issues in terms of safety of use, disposal, and waste management.

Moreover, magnesium and aluminum are capable of providing higher volumetric capacity than lithium (3832, 8043, and 2062 mAh/cm³ for Mg, Al, and Li, respectively).

With reference to FIG. 1, a typical aluminum battery configuration can comprise: a) an anode consisting of a metal aluminum foil; b) a liquid electrolyte consisting, for example, of a chloroaluminate ionic liquid (1-ethyl-3-methylimidazolium chloride), to which aluminum chloride (AlCl₃) is added in an appropriate molar ratio; and c) a cathode based on graphite materials.

However, aluminum batteries show certain disadvantages, mainly related to the fact that the aluminum ion (valence 3+) has a high charge density which: a) inhibits reactions to electrodes by limiting the reactivity thereof (e.g., intercalation/deintercalation kinetics); and b) lowers the conductivity of electrodes and electrolytes.

Moreover, the high chemical affinity of aluminum for oxygen and the associated tendency to oxidize can generate oxide layers on the anode with associated passivation thereof and reduction in aluminum ion plating/stripping capabilities.

From an electrochemical point of view, it is known that although pure aluminum shows good properties as an anode, it: a) is particularly prone to corrosion phenomena that reduce the stability thereof during repeated charge/discharge processes; b) shows low coulombic efficiency and practical capacity; c) shows slow reactivity; and d) is particularly prone to dendrite growth following repeated plating/stripping processes.

Patent document CN108642327B (INSTITUTE OF MATERIALS & PROCESSING GUANGDONG ACADEMY OF SCIENCES) describes a material for manufacturing anodes with aluminum-air cells comprising, in addition to aluminum: gallium, lead, bismuth, iron, titanium (0.005-0.015%), boron (0.001-0.003% by weight) and less than 0.003% silicon.

Patent applications CH-679438 and CH-679437 (ALUSUISSE LONZA GROUP, PAUL SCHERRER INSTITUTE) describe batteries with an anode made of aluminum or aluminum alloy and one or more other elements, including lithium, magnesium, silicon, titanium, and boron, where a strongly acidic electrolyte is used to manufacture the battery.

The aluminum/air batteries mentioned above represent a technology including the use of aqueous electrolytes and non-solid cathodes (e.g., air or oxygen) and have major problems with reversibility, coulombic efficiency, operating voltage, capacity fade, shelf-life, as well as inadequate mobility of Al³⁺ ions within the aqueous electrolyte.

International patent application WO 2018/90097 (NEWSOUTH INNOVATIONS PTY LIMITED) describes electrochemical cells for the manufacturing of batteries, in which the anode is made of aluminum or an aluminum/lithium alloy and the cathode of sulfur, while the electrolyte comprises lithium ions.

International patent application WO 2022/55968 (Everon24, Inc.) describes the manufacturing of a surface layer in the form of a coating (about 100 μm thick) of materials (typically oxides) on the surface of anodes or cathodes in aluminum batteries for the purpose of improving the ion transfer capability or inhibiting the formation of by-products at the interface between anode and electrolyte.

U.S. patent application US 2004/170523 describes a metal alloy of general formula AlTi1-2B1-2 for die casting of safety components in automotive manufacturing; such an alloy is to be characterized by particular mechanical properties, including high elongation in the cast state.

U.S. patent application US 2012/134874 describes a metal alloy of general formula AlSi5-13Ti1-3B1-3 for use in the automotive industry, which has particular elasticity in comparison with alloys which do not comprise the addition of titanium and boron.

U.S. patent application US 2013/136651 describes a metal alloy of formula AlSi5-13Ti2-7B1-3, which is characterized by improved elastic properties and is suitable for high-pressure molding processes.

Therefore, at present, there is a need to develop aluminum-based anodes, which are free from the drawbacks above mentioned.

### SUMMARY OF THE INVENTION

The inventors of the present invention surprisingly found that aluminum alloys having the general formula: AlSiXTiYBZ can be used to manufacture anodes for aluminum (Al) batteries.

The use of these alloys allows obtaining anodes with high efficiency, reactivity, and reversibility to manufacture high-performance batteries.

### OBJECT OF THE INVENTION

Therefore, in a first object, aluminum alloys obtained by means of a particular process are described.

In a second object, the process for preparing the aluminum alloys of the invention is described.

Aluminum alloys as such are particular aspects of the invention.

In a third object, anodes made from the aluminum alloys of the invention and batteries comprising such anodes are described.

### BRIEF DESCRIPTION OF THE DRAWINGS

FIG. 1 diagrammatically depicts a battery, with particular reference to the charge migration processes which occur during the discharge process.

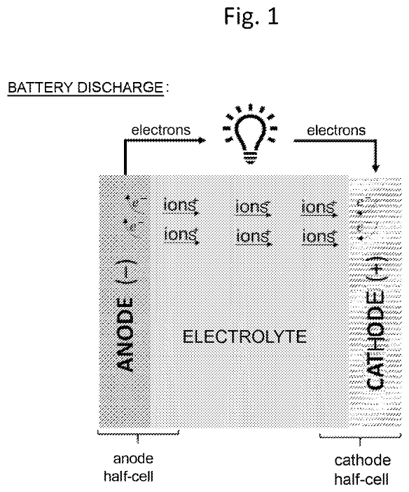

FIG. 2 shows the graph with the results of aluminum plating/stripping measurements obtained using the alloys of the present patent application as the working electrode. The box shows measurements for a pure aluminum electrode and an EN-43200 alloy electrode as a reference.

FIG. 3 shows images of the metallographic analysis of the AlSi7Ti8B4 alloy.

FIG. 4 shows the galvanostatic charge/discharge profiles in a performance assay.

### DETAILED DESCRIPTION OF THE INVENTION

In accordance with a first object of the invention, aluminum alloys are described.

In particular, said alloys comprise at least 75% by weight of aluminum.

More in particular, said alloys comprise boron and possibly also silicon and/or titanium in addition to aluminum.

For the purposes of the present invention, such alloys have the following formula:

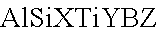

wherein
X, Y and Z are the weight percentage of each element, silicon, titanium and boron, respectively, and
wherein

$$0 \leq X \leq 10$$

$$0 \leq Y \leq 10$$

$$2 \leq Z \leq 5 .$$

According to a more preferred aspect of the invention, the alloys described have the following formula

AlSiXTiYBZ
wherein X, Y, and Z are the weight percentage of each element, silicon, titanium, and boron, respectively, and where

$$5 \leq X \leq 10$$

$$0 \leq Y \leq 10$$

$$2 \leq Z \leq 5 .$$

According to an even more preferred aspect of the invention, the alloys described have the following formula

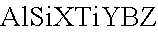

wherein X, Y, and Z are the weight percentage of each element, silicon, titanium, and boron, respectively, and
wherein

$$5 \leq X \leq 10$$

$$4 \leq Y \leq 8$$

$$2 \leq Z \leq 5 .$$

Examples of alloys according to the present invention are, for example: AlSiB2, AlSi6B2, AlSi5B2, AlSi6Ti7B3, AlSi6Ti4B2, AlSi7Ti8B4 and AlTi0.3.

Examples of preferred alloys according to the present invention are, for example: AlSi6Ti7B3, AlSi6Ti4B2 and AlSi7Ti8B4.

In accordance with a second object, it is described a process for preparing the alloys of the invention.

In particular, such an alloy can be obtained by direct casting of the constituent elements: aluminum, silicon, titanium, and boron.

Alternatively, the alloy can be obtained by casting from appropriate binary aluminum alloys (“parent” alloys), to which the missing elements are then added, again by casting, in appropriate amounts.

For the purposes of the present invention, binary aluminum alloys (“parent” alloys) can comprise, for example: aluminum-titanium alloys, such as: AlTi10, AlTi15, for example, or aluminum-boron, such as: AlB4, AlB6, AlB10, for example.

According to a preferred aspect of the present invention, the casting temperature is above 660° C., and in an even more preferred aspect, is between 70° and 900° C.

The analysis of the alloys obtainable according to the process of the invention showed the presence of metal and intermetal elements represented by: Al (matrix), Si, Fe (traces) and Ti (traces), and AlTiSi, TiB2, AlB12, AlB2, and AlSiFe (wherein Fe is introduced as an impurity present in parent alloys or in molten metal preparations).

For the purposes of the present invention, the order of the elements reflects the concentration of the elements in the compound; for example, for the intermetal AlTiSi, the elemental concentration follows the order [Al]>[Ti]>[Si], similarly the intermetal compound SiTiAl mainly consists of silicon followed by titanium and aluminum.

Intermetal compounds are represented by TiAl2.55Si0.45, for example.

As for the traces, each element present in traces amounts to a concentration<0.5% (w/w).

In a preferred aspect, the trace elements are present in the form of oxides (e.g., MgO and Fe₂O₃).

According to a preferred aspect of the present invention, the alloys obtainable according to the process described above have shown the presence of ceramic precipitates.

Such (“noble”) ceramic precipitates are characterized by a higher corrosion potential than the matrix in which they are embedded i.e., they are electrochemically nobler than aluminum.

According to a particularly preferred aspect of the present invention, the alloys obtainable according to the process described above have shown the presence of non-stoichiometric aluminum and/or titanium borides.

For the purposes of the present invention, said non-stoichiometric aluminum and/or titanium borides can be represented by Al1.67B22 and Ti0.93B2.

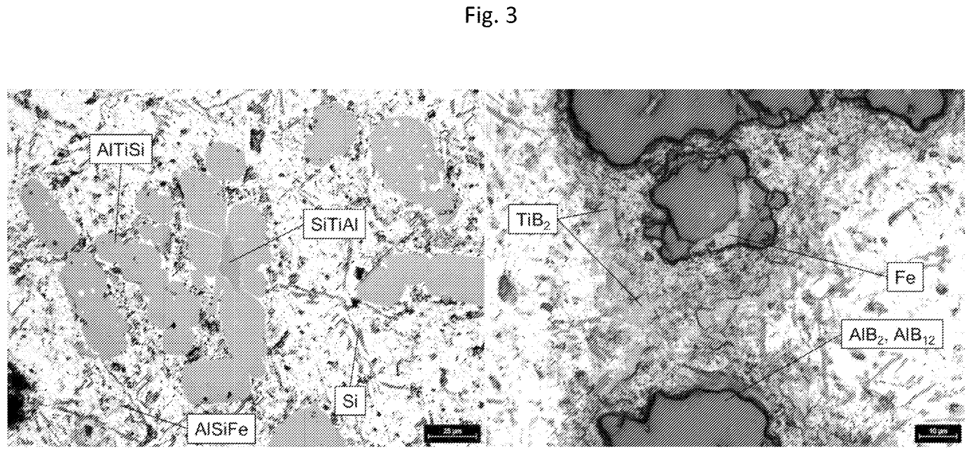

Metallographic analyses coupled with EDXS (Energy-Dispersive X-ray Spectroscopy) measurements have shown that the thus-obtained alloys consist of an aluminum matrix in which metal and intermetal elements are dispersed (see FIG. 3).

The following table shows examples of alloys obtained by casting appropriate parent alloys and adding aluminum and/or silicon.

The casting temperatures define appropriate intermetal elements, the presence and composition of which were confirmed by EDXS and metallographic analyses.

| | | | Casting | % Element | | | |
|---|---|---|---|---|---|---|---|
| | | | Temp. | weight | | | Main phases and |
| Ref. | Alloy | Synthesis | (° C.) | Si | Ti | B | intermetal elements |
| Ref. 1 | EN-43200 (T6) | Commercial | | 10 | 0.15 | | Al + Si + AlSiFeMn (Cu) + Mg₂Si |
| Ref. 2 | Al (99.8%) | Commercial | | — | — | — | Al |
| Ex. 1 | AlB2 | AlB4 + Al | 750-770 | — | — | 2 | Al + AlB₁₂ + AlB₂ |
| Ex. 2 | AlSi6B2 | AlB4 + Al + Si | 720-740 | 6 | — | 2 | Al + Si + AlB₂ + AlB₁₂ |
| Ex. 3 | AlSi5B2 | AlB4 + Al + Si | 720-740 | 5 | — | 2 | Al + Si + AlB₂ + AlB₁₂ |
| Ex. 4 | AlSi6Ti7B3 | AlTi10 + AlB4 + Si | 800-850 | 6 | 7 | 3 | Al + Si + AlTiSi + TiB₂ + AlB₁₂ + |
| | | | | | | | AlB₂ + AlSiFe |
| Ex. 5 | AlSi6Ti4B2 | AlTi15 + AlB6 + Si | 800-850 | 6 | 4 | 2 | Al + AlTiSi + AlSiFe + Si + TiB₂ + |
| | | | | | | | AlB₁₂ + AlB₂ + Fe (traces) |
| Ex. 6 | Alsi7Ti8B4 | AlTi15 + AlB10 + Si | 800-850 | 7 | 8 | 4 | Al + AlTiSi + SiTiAl + Si + TiB₂ + |
| | | | | | | | AlB₁₂ + AlB₂ + Ti (traces) + Fe |
| | | | | | | | (traces) + AlSiFe |
| Ex. 7 | AlTi0.3 | AlTi10 + Al | 750-770 | — | 0.3 | — | Al + TiAl₃ |

In a third object of the invention, the thus-obtained alloys can be used for the preparation of an anode.

For this purpose, the alloy can be cast by gravity in appropriate molds.

According to a further aspect of the invention, an anode made from a metal alloy as described above can be used, together with a cathode, to manufacture a battery.

Certain aluminum alloys prepared according to the present invention have been electrochemically and metallographically characterized as follows.

a. Electrochemical Characterization

Aluminum alloys prepared according to the present invention were characterized by means of plating/stripping measurements of aluminum in a suitable electrolyte.

Such measurements reproduce the behavior of an anode half-cell of an aluminum battery and allow the reversibility and efficiency of oxidation/reduction reactions occurring at the anode of a battery.

The following measurements are shown for reference: a) a measurement of a pure aluminum electrode; and b) a measurement of an electrode made of EN-43200(T6) alloy comprising silicon as the main alloying element (10 wt %) AlSi10Mg(Cu) (UNI EN 1676).

Specifically, measurements were carried out using a three-electrode setup as follows: 1) working electrode (WE): alloy sample according to the invention with a known area; 2) counter electrode (CE): aluminum foil (99.8%) with area at least twice that of the WE; 3) reference electrode: alloy sample according to the invention.

The used electrolyte is a solution of 1-ethyl-3-methylimidazolium chloride and AlCl₃ in a molar ratio of 1:1.5 at 25° C.; this electrolyte is commonly used as an electrolyte for aluminum batteries.

The scan rate used is 50 mV/s.

Aluminum plating/stripping measurements allow the evaluation of the interface properties of an electrode in contact with an electrolyte.

In particular, negative currents are associated with the reduction process (Al³⁺+3e⁻→Al⁰) in combination with Al plating from the electrolyte, while positive currents are associated with the oxidation process (Al⁰→Al³⁺+3e⁻) and related to the injection of aluminum ions from the anode to the electrolyte.

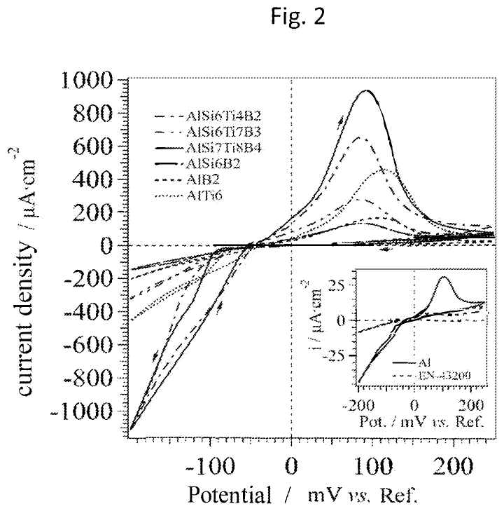

The results are given in the table below and shown in the graph in FIG. 2.

| | | Anode peak | Anode peak | |
|---|---|---|---|---|
| | | current/ | potential/ | |
| | Alloy | μA-cm⁻² | mV vs. Ref. | Performance |
| Ref. 1 | EN-43200 (T6) | nd | nd | ↓↓ |
| Ref. 2 | Al (99.8%) | 31 | 105 | ↓ |
| Ex. 1 | AlB2 | 165 | 109 | → |
| Ex. 2 | AlSi6B2 | 115 | 115 | → |
| Ex. 3 | AlSi5B2 | 133 | 87 | ↑ |
| Ex. 4 | AlSi6Ti7B3 | 275 | 85 | ↑ |
| Ex. 5 | AlSi6Ti4B2 | 652 | 85 | ↑↑ |
| Ex. 6 | AlSi7Ti8B4 | 935 | 91 | ↑↑↑ |
| Ex. 7 | AlTi0.3 | 456 | 112 | ↑↑ |

It is apparent from the results that: a) high current densities, b) presence of well-defined peaks (reduced width at mid-height), and c) reduction-oxidation potentials close to 0 mV vs. Ref. should be pursued and are associated with high reactivity, reversibility, and efficiency of the investigated electrode.

From the data, it can be seen that all the invention alloys exhibit markedly higher oxidation and reduction current densities than aluminum as such.

In particular, in the case of the alloy of Example 6, the peak current (under oxidation) is about 30 times higher than that of aluminum.

Moreover, the voltammetric profile for alloy Ref. 1 shows poorly defined peaks and negligible currents compared to both the alloys of the invention and pure aluminum.

EN-43200 alloy contains silicon in a concentration of 9 to 11% by weight, titanium in a concentration of about 0.15% by weight, and it does not comprise boron.

This evidence supports the fact that the excellent electrochemical performance of the alloys of the present invention can be obtained by virtue of the synergistic presence of silicon, titanium, and boron.

With particular reference to the binary alloys (AlB2 and AlTi6), in comparison with aluminum, it is seen that although they show significantly higher anodic peak currents, their peak potential is slightly higher, thus denoting less reversibility of the oxidation process.

Considering the peak current and the anodic peak potential as the figures of merit, it is seen that ternary (AlSi6B2) and quaternary (AlSi6Ti7B3, AlSi6Ti4B2, AlSi7Ti8B4) alloys exhibit the best performance.

Therefore, it arises that the performance of these materials is related to the co-presence of boron, silicon, or silicon, boron, and titanium in the aluminum matrix, which contribute to the formation and dispersion of appropriate phases and intermetal compounds in the aluminum matrix, which are particularly effective in modulating the reversibility of aluminum oxidation/reduction reactions, resulting in increased reactivity and efficiency of the alloys.

b. Metallographic Characterization

The image in FIG. 3 shows the metallographic analysis of AlSi7Ti8B4 alloy (Example 6).

This alloy was obtained by reaction of two parent alloys AlTi15 and AlB10 (at 850° C.) with silicon added, to obtain the following final elemental concentrations (% by weight): Si: 7%, Ti: 8% and B: 4%.

Metallographic analysis coupled with EDXS measurements allowed showing that the alloy consists of an aluminum matrix dispersing the following phases: AlTiSi, SiTiAl, TiB₂, AlB₁₂, AlB₂, Ti, Fe, Si, AlSiFe.

The formation of these phases, which is responsible for the electrochemical performance described in the present patent application, is optimizable by selecting the alloying elements based on the state diagrams thereof and by virtue of an appropriate casting temperature.

By operating in this manner, a specific microstructure is obtained, which allows the advantageous electrochemical properties described.

c. Battery Test

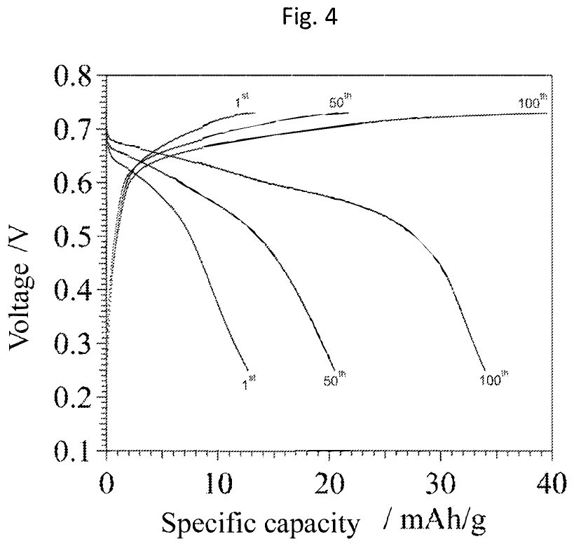

The performance of the AlSi6Ti8B4 alloy used as the anode was studied by means of a galvanostatic cycle in a prototype CR2032 battery. The results in FIG. 4 show a reversible behavior of the battery with specific capacity increasing from 13 mAh/g (1st cycle) to 34 mAh/g (100th cycle) and a discharge plateau centered around 600 mV. This trend indicates that promising cycling performance can be achieved using the suggested quaternary AlSi6Ti8B4 alloy.

From the foregoing description, the advantaged offered by the present patent application are immediately apparent.

The use of aluminum allows solving several critical issues related to the production of lithium-ion batteries.

First, it has four times the volumetric energy capacity, it is not harmful to humans, it requires less energy consumption to be produced, and it also requires less earth movement during mining operations by virtue of its greater abundance on the Earth's crust.

The technology for the production, manufacture, recycling and disposal of aluminum-based batteries is well developed.

Moreover, since it is not air-flammable, it ensures a high safety of the batteries and the devices comprising them.

The supply of aluminum, then, has lower risks related to its supply with reference to the geopolitical conditions than lithium and other elements, such as nickel and cobalt, used in the battery production.

Aluminum alloys developed according to the present invention for the manufacturing of anodes, as substitutes for pure aluminum, can inhibit the formation of a passivating oxide layer on the electrode surface, create high surface energy interfaces capable of facilitating the Al³⁺ plating/stripping processes, improve the structural stability at the electrode by limiting any breakup processes following cycling, limit dendritic growth, and generate galvanic micro-coupling phenomena capable of modulating the reactivity of the electrode surface by limiting the passivation thereof and facilitating the ionic conduction at the interface with the electrolyte.

The performance offered demonstrates that the suggested alloys are a clear advancement over the prior art in this field and allow the access to energy densities never achieved before in the aluminum battery industry.

1-13. (canceled)

14. A metal alloy of general formula:
AlSiXTiYBZ
wherein
X, Y and Z are the weight percentage of each element, silicon, titanium and boron, respectively, and
wherein
$$0 \leq X \leq 10$$
$$0 \leq Y \leq 10$$
$$2 \leq Z \leq 5$$
obtainable by means of a process comprising the direct casting of constituent elements or comprising the casting of binary aluminum alloys, to which the missing elements are added, wherein said casting is carried out at a temperature between 70° and 900° C.

15. A metal alloy obtainable according to claim 14 having general formula
AlSiXTiYBZ
wherein
X, Y and Z are the weight percentage of each element, silicon, titanium and boron, respectively, and
wherein
$$5 \leq X \leq 10$$
$$0 \leq Y \leq 10$$
$$2 \leq Z \leq 5.$$

16. A metal alloy obtainable according claim 15 having general formula 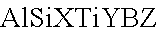
wherein
X, Y and Z are the weight percentage of each element, silicon, titanium and boron, respectively, and
wherein
$$5 \leq X \leq 10$$
$$4 \leq Y \leq 8$$
$$2 \leq Z \leq 5.$$

17. A metal alloy obtainable according to claim 14, selected from the group comprising: AlSi6B2, AlSi6Ti7B3, AlSi6Ti4B2 and AlSi7Ti8B4.

18. A metal alloy obtainable according to claim 14, further comprising metal and intermetal elements represented by: Si, AlTiSi, TiB2, AlB12, AlB2, AlSiFe, Fe (traces) and Ti (traces).

19. A metal alloy obtainable according to claim 14, comprising non-stoichiometric aluminum borides and/or non-stoichiometric titanium borides.

20. A process for preparing a metal alloy of general formula: 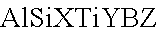
wherein
X, Y and Z are the weight percentage of each element, silicon, titanium and boron, respectively, and
wherein
$$0 \leq X \leq 10$$
$$0 \leq Y \leq 10$$
$$2 \leq Z \leq 5 ,$$
comprising the direct casting of the constituent elements or comprising the casting of binary aluminum alloys, to which the missing elements are added, wherein said casting is carried out at a temperature between 70° and 900° C.

21. A metal alloy of general formula: 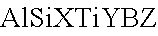
where
X, Y and Z are the weight percentage of each element, silicon, titanium and boron, respectively, and
where
$$0 \leq X \leq 10$$
$$0 \leq Y \leq 10$$
$$2 \leq Z \leq 5 ,$$
further comprising metal and intermetal elements represented by: Si, AlTiSi, TiB2, AlB12, AlB2, AlSiFe, Fe (traces) and Ti (traces).

22. A metal alloy according to claim 21,
wherein
X, Y and Z are the weight percentage of each element, silicon, titanium and boron, respectively, and
wherein
$$5 \leq X \leq 10$$
$$0 \leq Y \leq 10$$
$$2 \leq Z \leq 5 ,$$
further comprising metal and intermetal elements represented by: Si, AlTiSi, TiB2, AlB12, AlB2, AlSiFe, Fe (traces) and Ti (traces).

23. A metal alloy according to claim 22,
wherein
X, Y and Z are the weight percentage of each element, silicon, titanium and boron, respectively, and
wherein
$$5 \leq X \leq 10$$
$$4 \leq Y \leq 8$$
$$2 \leq Z \leq 5 ,$$
further comprising metal and intermetal elements represented by: Si, AlTiSi, TiB2, AlB12, AlB2, AlSiFe, Fe (traces) and Ti (traces).

24. A metal alloy according to claim 23, comprising non-stoichiometric aluminum borides and/or nonstoichiometric titanium borides.

25. A battery anode made from a metal alloy according to claim 14.

26. A battery comprising a cathode and an anode, wherein said anode is the anode claim 25.
